(19) United States
(12) Patent Application Publication
(10) Pub. No.: US 2013/0169509 A1
(43) Pub. Date: Jul. 4, 2013

(54) HANDHELD CONTROL DEVICE WITH DUAL DISPLAY SCREENS

(71) Applicant: Measurement Systems, Inc., Wallingford, CT (US)

(72) Inventors: Michael Chen, Naugatuck, CT (US); Thomas Robert Ecsedy, Woodbury, CT (US); Raymond J. Paquette, East Haddam, CT (US)

(73) Assignee: Measurement Systems, Inc., Wallingford, CT (US)

(21) Appl. No.: 13/633,986

(22) Filed: Oct. 3, 2012

Related U.S. Application Data
(60) Provisional application No. 61/548,266, filed on Oct. 18, 2011.

(51) Int. Cl. G09G 5/00

(52) U.S. Cl. CPC G09G 5/00
USPC 345/1.3

(57) ABSTRACT

A portable operator control unit (OCU) includes a main portion disposed between handle portions extending from the main portion; the main portion has a front side, an opposing back side, and a top surface. The OCU includes a plurality of display devices including a primary display disposed on the front side of the main portion, and a secondary display movable with respect to the main portion. The secondary display is viewable by the operator along with the primary display while the secondary display is in use, and is stowed out of the operator's view while the secondary display is not in use.

### CROSS-REFERENCE TO RELATED APPLICATIONS

This application claims the benefit of U.S. Provisional Application No. 61/548,266, filed Oct. 18, 2011, the disclosure of which is incorporated herein by reference in its entirety.

### FIELD OF THE DISCLOSURE

This disclosure relates to handheld, portable control units, and more particularly to a human-portable operator control unit (OCU) that incorporates dual display operation for functional use in harsh environments (e.g. in military and industrial applications).

### BACKGROUND OF THE DISCLOSURE

Portable, handheld control units have been developed where an operator may control various features of complex equipment, such as a military or law enforcement vehicle. Units such as described in U.S. Pat. No. 7,471,216 (the entire disclosure of which is incorporated herein by reference) permit an operator to control equipment related to weaponry, countermeasures, communications, and surveillance, in addition to movement of the vehicle (e.g., direction, speed, altitude, depth, etc.).

A desirable feature of OCUs, particularly units for controlling vehicles, is a display for providing a real-time view of the vehicles' environment, and/or feedback with respect to any controls activated by the operator. OCUs have been developed that have one or more displays. In particular, multi-display OCUs have been ruggedized and adapted for functional use in harsh environments. However, these units are not human-portable due to the size, weight, and power requirements of their system and hence render them ineffective for dismounted operations.

Accordingly, there is a need for an OCU, suitable for use in military and industrial environments, having multiple displays and offering the convenience of handheld operation.

### SUMMARY OF THE DISCLOSURE

In accordance with the disclosure, a portable operator control unit includes multiple displays. In particular embodiments, an OCU includes two displays providing manipulation, control, and real time video information for operator feedback, and whereby the two displays may be used in conjunction for intuitive operation of a remotely controlled device.

According to embodiments of the disclosure, a portable operator control unit (OCU) includes a main portion disposed between handle portions extending from the main portion; the main portion has a front side, an opposing back side, and a top surface. The OCU includes a plurality of display devices including a primary display disposed on the front side of the main portion, and a secondary display movable with respect to the main portion. The secondary display is viewable by the operator along with the primary display while the secondary display is in use, and is stowed out of the operator's view while the secondary display is not in use.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a rear perspective view of a portable controller according to a first embodiment of the disclosure, showing a secondary display in its stowed position.

FIG. 2 is a rear perspective view of the controller of FIG. 1, showing the secondary display in use.

FIG. 3 is a front perspective view corresponding to FIG. 2, showing the primary display and the secondary display in use.

FIG. 4 is a rear perspective view of a portable controller according to a second embodiment of the disclosure, showing a secondary display in its stowed position.

FIG. 5 is a rear perspective view of the controller of FIG. 4, showing the secondary display in use.

FIG. 6 is a front perspective view corresponding to FIG. 5, showing the primary display and the secondary display in use.

FIG. 7 is a rear perspective view of a portable controller according to a third embodiment of the disclosure, showing a secondary display mounted on the controller and in use.

FIG. 8 is a front perspective view corresponding to FIG. 7, showing the primary display and the secondary display in use.

### DETAILED DESCRIPTION

In the embodiments described herein, a dual display portable control device includes a primary display mounted on a front face of the device, and a secondary display above the primary display. The primary display is disposed between two handles and typically is used for command and control. The primary display is mounted so as to minimize operator fatigue and cognitive load, and to maximize operator capability. The primary display is normally always in use and provides two way command, control, and data information for the operator. The secondary display is also sized and mounted to minimize operator fatigue and cognitive load. The secondary display is used in applications requiring video information in addition to the information presented on the primary display and still minimize cognitive load and maximize operator capability. The secondary display can be stowed when not in use, providing truly portable operation. The dual display OCU increases situational awareness of the dismounted operator while minimizing cognitive burden.

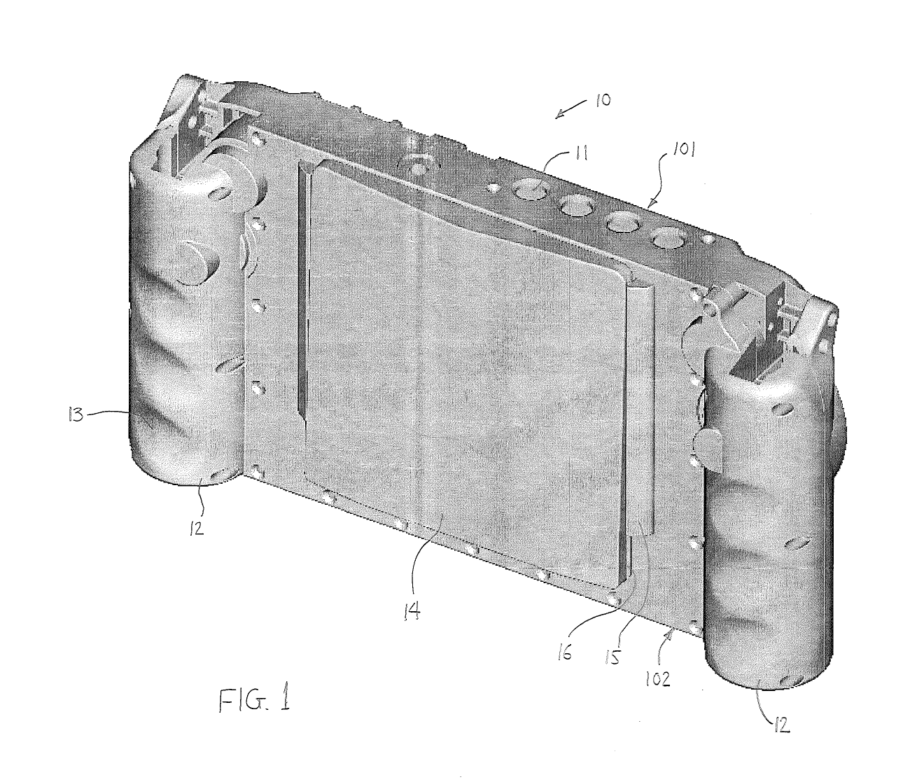

FIGS. 1-3 illustrate a dual display OCU 10 (e.g. for a vehicle) according to a first embodiment. Control unit 10 has a main central portion with front and back sides 101, 102, and outer handle portions 12. Handle portions 12 may have contours 13 formed therein to provide a comfortable grip for the operator's fingers. As shown in FIG. 1, the top surface of the main portion may have one or more control buttons 11 for controlling various features of the vehicle.

In FIG. 1, secondary display 14 is not in use and is shown in its stowed position on the back side of the unit, on the opposite side from the primary display. The screen of the secondary display faces inwards toward back side 102 to protect the screen while the display is not in use. The handles 12 on either side of the display provide additional protection. The secondary display 14 is held tightly against the back side of the unit; accordingly, when the secondary display is stowed and secured, the unit provides convenient operator use with only the primary display.

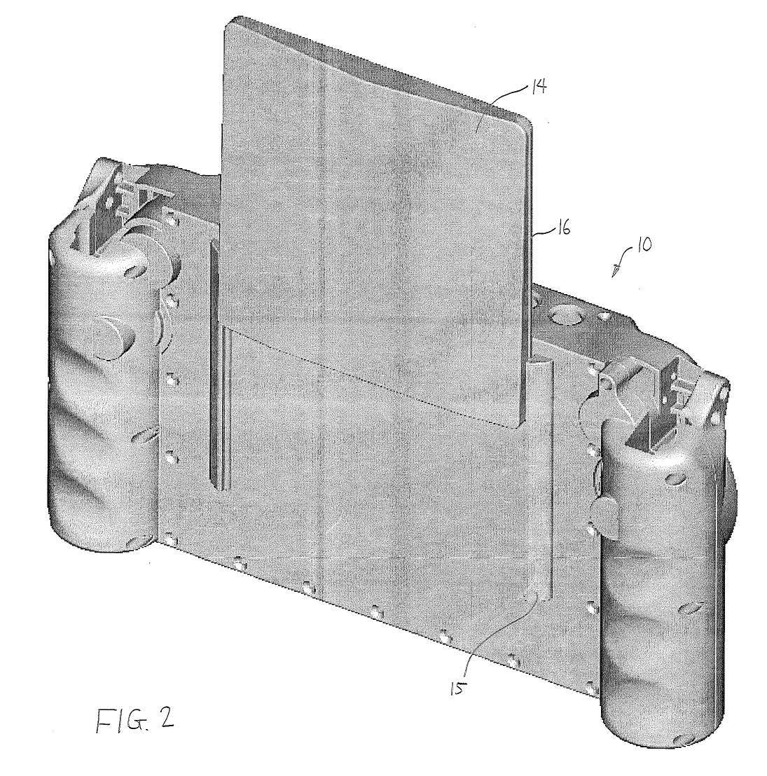

The secondary display 14 is slidably disposed between members 15 protruding from and integral with the back side 102 of the unit. Display 14 has flanges 16 at opposite vertical edges thereof, engaging members 15 so as to form a sliding mechanism. When in use, secondary display 14 moves up (see FIG. 2) so that it is visible from the front of the unit, using the sliding mechanism. The secondary display has a cable attachment for feeding power and a video signal to the display. The sliding mechanism may also have a boot attachment to keep dirt and debris from impacting the sliding movement of the secondary display.

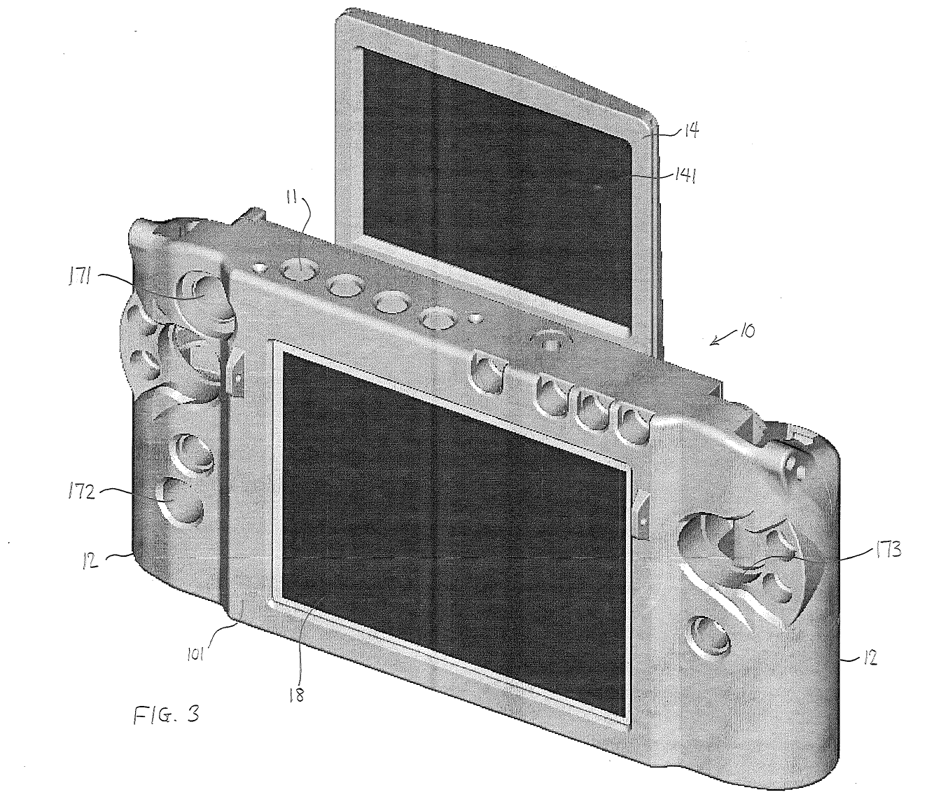

FIG. 3 shows the front of controller unit 10 with the secondary display 14 in use. The primary display 18 is disposed on the front side 101 of the main portion of the unit; handles 12 are located on either side and are formed to provide a comfortable grip. In particular, portions of the handles may be formed to accommodate the user's thumbs, and the handles may include buttons and/or switches 171-173 which may conveniently be activated by the user's thumbs.

As shown in FIG. 3, the secondary display has a screen 141 with a size equal to or smaller than that of the primary display 18. In this embodiment, screen 141 of secondary display 14 is an LCD display. The primary display 18 may show the layout of the controls and their functions (a map of the control device) along with text informing the user of the status of various features or devices being controlled. In this embodiment, the primary display may be understood as a computer monitor (supported by, for example, a Windows® based operating system). The secondary display 14 may show real-time video images of the environment (that is, functioning as a TV monitor). This is particularly useful for an operator of a vehicle who does not have a good view of the vehicle's surroundings. The operator thus can view directly the results of activation of various controls. Accordingly, in this embodiment the primary display shows the operator what controls are available and their status, while the secondary display provides visual feedback with respect to the controls. Both displays may be conveniently viewed by the operator at the same time.

When in use, the sliding mechanism in this embodiment provides a physically robust connection to the unit, and accordingly serves to prevent damage to the unit (e.g. when dropped on a hard surface).

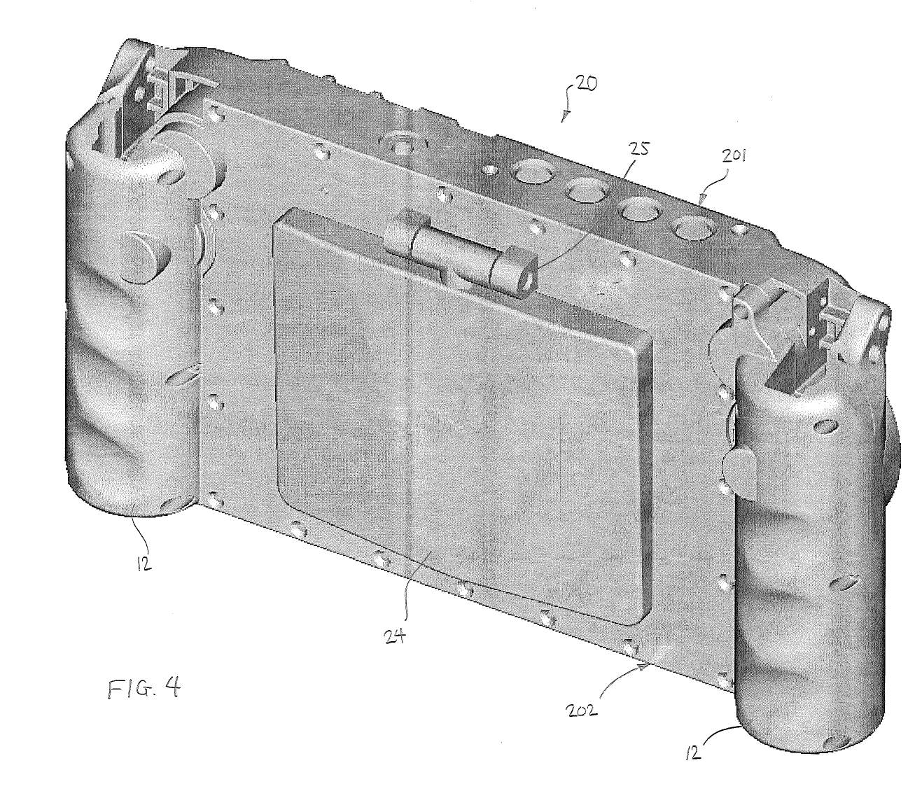

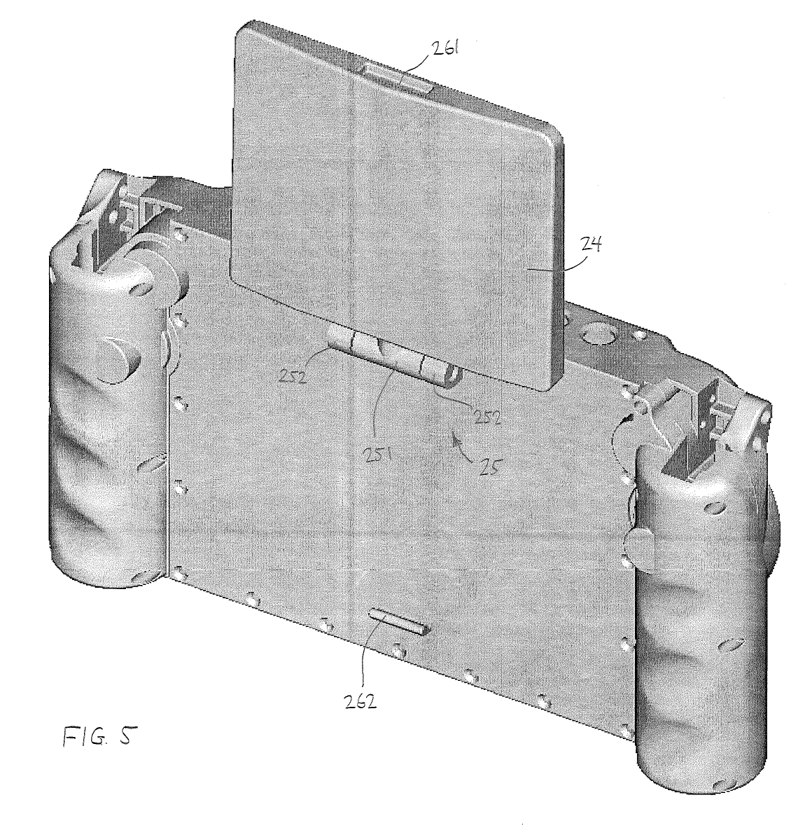

FIGS. 4-6 illustrate a dual display OCU 20 according to a second embodiment. Control unit 20 has a main central portion between handles 12, with a front side 201 and a back side 202. The secondary display 24 is on the back side 202 of the unit when not in use, on the opposite side from the primary display. The screen of the secondary display 24 faces inwards toward back side 202 to protect the screen while the display is not in use. The handles 12 on either side of the display provide additional protection. The secondary display is held tightly against back side 202 when stowed and secured, providing effective operator use with the primary display only. As shown in FIG. 5, secondary display 24 may also be provided with a snap-lock mechanism to secure it into its stowed position; when secondary display 24 is stowed, indentation 261 in the upper edge thereof mates with protrusion 262 integral with the back side 202, positively securing the secondary display against the back side when not in use.

When in use, secondary display 24 flips upward using universal joint mechanism 25 (see FIG. 5). Mechanism 25 has a rotatable portion 251 captured between two fixed portions 252 integral with the back side 202 of unit 20; portion 251 further includes a pivot. When removed from its stowed position and put into use, secondary display 24 first rotates about the axis of portions 252, and then pivots to face toward the operator.

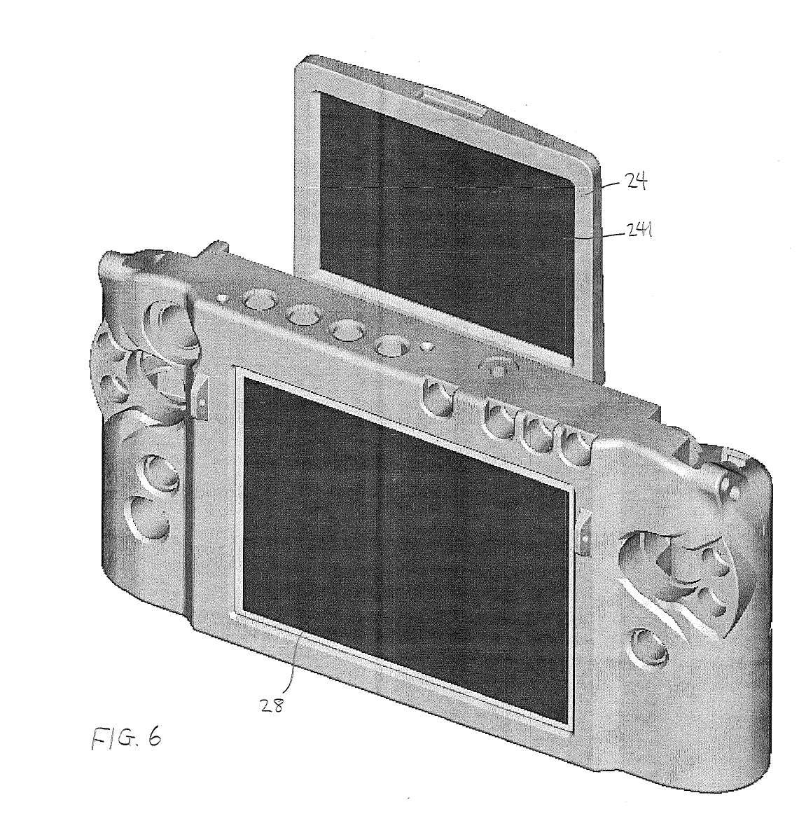

FIG. 6 is a front view of unit 20 with secondary display 24 in use. As in the first embodiment, secondary display 24 has a screen 241 slightly smaller than that of primary display 28. When in use, the joint mechanism in this embodiment provides a physically robust connection to the unit, and accordingly serves to prevent damage to the unit (e.g. when dropped on a hard surface).

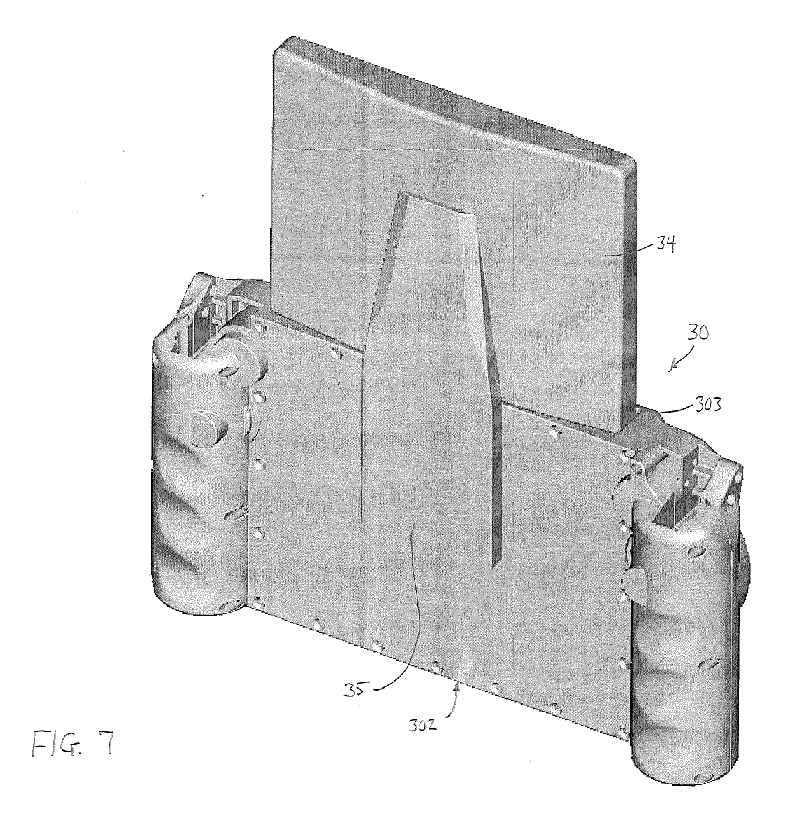

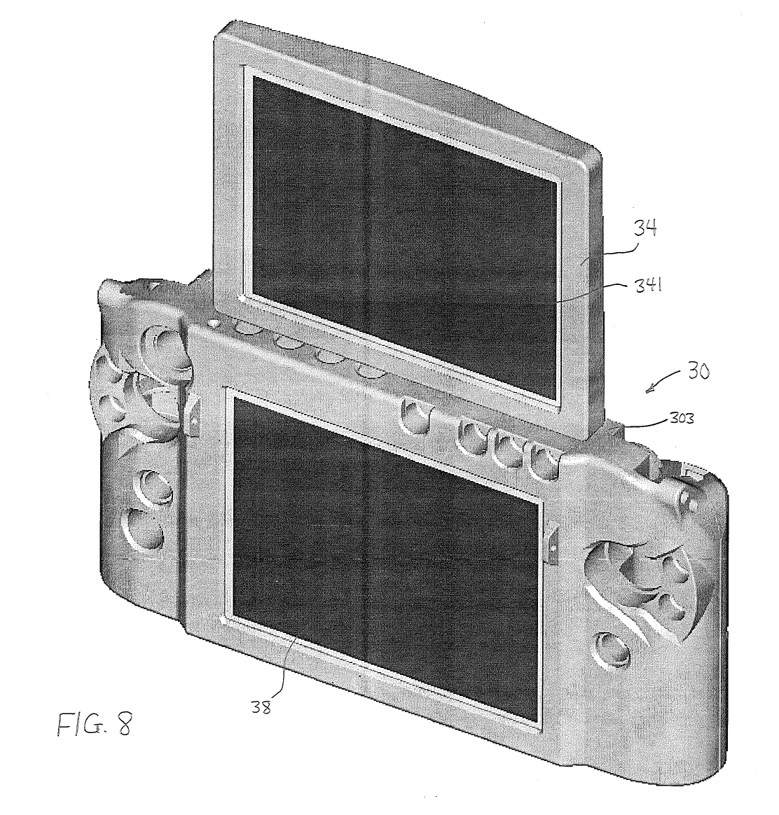

FIGS. 7 and 8 illustrate a dual display OCU 30 according to a third embodiment. In this embodiment, secondary display 34 is detachable and is stored separately from unit 30. The secondary display 34 includes a mechanical and electrical attachment interface 35, which is configured to connect with unit 30 at the back side 302 thereof (see FIG. 7). The lower edge of secondary display 34 may be provided with a snap-lock mechanism (not shown), so that secondary display snaps and locks into place on the top surface 303 of unit 30. In this embodiment, since the secondary display is stowed separately, the secondary display 34 may be larger than in the preceding embodiments, and may have a screen 341 approximately the same size as that of primary display 38 (see FIG. 8). When in use, the mechanical attachment in this embodiment provides a physically robust connection to the unit, and accordingly serves to prevent damage to the unit (e.g. when dropped on a hard surface).

An operator control unit 10, 20, 30 embodying this disclosure is portable (being of small size and light weight) and provides handheld operation, while being ruggedized for harsh environments. An OCU embodying this disclosure may also feature low power consumption, and may be powered by either an internal battery or an external power source.

It will be appreciated that an OCU according to the above-described embodiments may be configured to interface with an external processing unit or may incorporate an internal processing unit. Furthermore, an OCU embodying this disclosure may incorporate human-machine interface components such as joysticks, control buttons, triggers, trigger guards, touch screen, and keypad; may incorporate biometric devices such as thumbprint scanners and ID card readers; and may have wireless communications interfaces, wired communications interfaces and expansion ports for memory cards, docking stations, and additional communications ports.

A dual display OCU embodying this disclosure is functional for use in harsh environments. Typical applications include dismounted Fill-Motion Video (FMV) tracking; Remote Sensor Control; Remote Breacher System; Remote Weapons Control; Remote Perimeter Protection; Enhanced RSTA (Reconnaissance/Surveillance/Target Acquisition); and Simultaneous Command and Control of multiple unmanned platforms.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

What is claimed is:

1. A portable operator control unit (OCU) comprising:
a main portion disposed between handle portions extending from the main portion, the main portion having a front side, an opposing back side, and a top surface; and
a plurality of display devices including
a primary display disposed on the front side of the main portion, and
a secondary display movable with respect to the main portion, wherein
the secondary display is viewable by the operator along with the primary display while the secondary display is in use, and
the secondary display is stowed out of the operator's view while the secondary display is not in use.

2. An OCU according to claim 1, wherein the secondary display has a front surface including a display screen, and said display screen is proximate to the back side of said main portion while the secondary display is not in use.

3. An OCU according to claim 2, further comprising a sliding mechanism wherein the secondary display is slidably attached to the main portion, said display screen being viewable by the operator above the top surface of the main portion in accordance with the secondary display slid upwards against said back side when in use.

4. An OCU according to claim 2, further comprising a joint mechanism having a rotatable portion and a pivot, wherein the secondary display is attached to the main portion via the joint mechanism, said display screen being viewable by the operator above the top surface of the main portion in accordance with the secondary display rotated and pivoted with respect to the back side when in use.

5. An OCU according to claim 4, wherein the secondary display further comprises a snap-lock mechanism for positively holding the secondary display against the back side when not in use.

6. An OCU according to claim 1, wherein the secondary display is detachable from the main portion and includes a mechanical and electrical attachment interface for attaching to the main portion at said backside when the secondary display is in use.

7. An OCU according to claim 6, wherein the secondary display further comprises a snap-lock mechanism for positively holding the secondary display against the top surface when in use.

8. An OCU according to claim 6, wherein the secondary display includes a display screen having a size approximately that of the primary display.

9. An OCU according to claim 1, wherein the secondary display has an LCD display screen.

10. An OCU according to claim 1, wherein the primary display has information regarding the status of control devices included in the OCU, and the secondary display has a real-time video image.
